(19) United States
(12) Patent Application Publication
(10) Pub. No.: US 2025/0063617 A1
(43) Pub. Date: Feb. 20, 2025

(54) RELAY COMMUNICATION METHOD, AND DEVICE

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN); Boyuan ZHANG, Dongguan (CN)

(21) Appl. No.: 18/939,264

(22) Filed: Nov. 6, 2024

Related U.S. Application Data
(63) Continuation of application No. PCT/CN2022/091401, filed on May 7, 2022.

(51) Int. Cl. H04W 76/14; H04W 76/20; H04W 92/18

(52) U.S. Cl. CPC H04W 76/14; H04W 76/20; H04W 92/18

(57) ABSTRACT

A relay communication method is applied to a first terminal, where a relay connection is established between the first terminal and a second terminal through a relay terminal, and the relay communication method includes: receiving, by the first terminal, a first message; where the first message includes at least one of the following: an end-to-end user identifier of the first terminal, or an end-to-end user identifier of the second terminal.

### CROSS-REFERENCE TO RELATED APPLICATION

This application is a Continuation Application of International Application No. PCT/CN2022/091401 filed on May 7, 2022, which is incorporated herein by reference in its entirety.

### TECHNICAL FIELD

Embodiments of the present disclosure relate to the field of communication, and more specifically, to a relay communication method and device.

### BACKGROUND

In terminal-to-terminal relay (UE-to-UE Relay) communication, an adaptation (ADAPT) layer is located above the PC5-Radio Link Control (RLC) layer. For a source terminal and a destination terminal, the adaptation (ADAPT) layer is located between the PC5-RLC layer and the PC5-Packet Data Convergence Protocol (PDCP). In the adaptation (ADAPT) layer, user identifiers of the source terminal and/or the destination terminal need to be contained for end-to-end transmission. However, how to allocate end-to-end user identifiers is a problem that needs to be solved.

### SUMMARY

The embodiments of the present disclosure provide a method and a device for relay communication.

In a first aspect, a relay communication method is provided, the relay communication method is applied to a first terminal, where a relay connection is established between the first terminal and a second terminal through a relay terminal, and the method includes:
receiving, by the first terminal, a first message; where the first message includes at least one of the following: an end-to-end user identifier of the first terminal, or an end-to-end user identifier of the second terminal.

In some embodiments, the first terminal is a source terminal and the second terminal is a destination terminal; or the first terminal is the destination terminal and the second terminal is the source terminal.

In a second aspect, a relay communication method is provided, the relay communication method is applied to a second terminal, where a relay connection is established between the second terminal and a first terminal through a relay terminal, and the method includes:
sending, by the second terminal, a first message; where the first message includes at least one of the following: an end-to-end user identifier of the first terminal, or an end-to-end user identifier of the second terminal.

In some embodiments, the first terminal is a source terminal and the second terminal is a destination terminal; or, the first terminal is the destination terminal and the second terminal is the source terminal.

In a third aspect, a relay communication method is provided, the relay communication method is applied to a relay terminal, where a relay connection is established between a first terminal and a second terminal through the relay terminal, and the method includes:
sending, by the relay terminal, a first message, or forwarding, by the relay terminal, the first message; where the first message includes at least one of the following: an end-to-end user identifier of the first terminal, or an end-to-end user identifier of the second terminal.

In some embodiments, the first terminal is a source terminal and the second terminal is a destination terminal; or, the first terminal is the destination terminal and the second terminal is the source terminal.

In a fourth aspect, a terminal device is provided for performing the method in the above first aspect.

Exemplarily, the terminal device includes functional modules for performing the method in the above first aspect.

In a fifth aspect, a terminal device is provided for performing the method in the above second aspect.

Exemplarily, the terminal device includes functional modules for performing the method in the above second aspect.

In a sixth aspect, a terminal device is provided for performing the method in the above third aspect.

Exemplarily, the terminal device includes functional modules for performing the method in the above third aspect.

In a seventh aspect, a terminal device is provided, the terminal device includes a processor and a memory; the memory is configured to store a computer program, and the processor is configured to invoke and execute the computer program stored in the memory, so as to enable the terminal device to perform the method in the above first aspect.

In an eighth aspect, a terminal device is provided, the terminal device includes a processor and a memory; the memory is configured to store a computer program, and the processor is configured to invoke and execute the computer program stored in the memory, so as to enable the terminal device to perform the method in the above second aspect.

In a ninth aspect, a terminal device is provided, the terminal device includes a processor and a memory; the memory is configured to store a computer program, and the processor is configured to invoke and execute the computer program stored in the memory, so as to enable the terminal device to perform the method in the above third aspect.

In a tenth aspect, an apparatus is provided for implementing the method of any one of the above first aspect to third aspect.

Exemplarily, the apparatus includes: a processor, configured to invoke a computer program from a memory and execute the memory, so as to enable a device equipped with the apparatus to perform the method of any one of the above first aspect to third aspect.

In an eleventh aspect, a computer readable storage medium is provided, the computer readable storage medium is configured to store a computer program, and the computer program enables a computer to perform the method of any one of the above first aspect to third aspect.

In a twelfth aspect, a computer program product is provided, the computer program product includes computer program instructions, and the computer program instructions enable a computer to perform the method of any one of the above first aspect to third aspect.

In a thirteenth aspect, a computer program is provided, where the computer program, upon being executed on a computer, enables the computer to perform the method of any one of the above first aspect to third aspect.

### BRIEF DESCRIPTION OF THE DRAWINGS

FIG. 1 is a schematic diagram of a communication system architecture applied in the embodiments of the present disclosure.

FIG. 2 is a schematic diagram of a UE-to-network relay transmission protocol stack in a 5G system.

FIG. 3 is a schematic diagram of a UE-to-UE Relay transmission protocol stack in a 5G system.

FIG. 4 is a schematic flow chart of a relay communication method, provided according to the embodiments of the present disclosure.

FIG. 5 to FIG. 7 are schematic flow charts of allocating end-to-end user identifiers, provided according to the embodiments of the present disclosure.

FIG. 8 is a schematic flow chart of another relay communication method, provided according to the embodiments of the present disclosure.

FIG. 9 is a schematic flow chart of yet another relay communication method, provided according to the embodiments of the present disclosure.

FIG. 10 is a schematic block diagram of a terminal device, provided according to the embodiments of the present disclosure.

FIG. 11 is a schematic block diagram of another terminal device, provided according to the embodiments of the present disclosure.

FIG. 12 is a schematic block diagram of yet another terminal device, provided according to the embodiments of the present disclosure.

FIG. 13 is a schematic block diagram of a communication device, provided according to the embodiments of the present disclosure.

FIG. 14 is a schematic block diagram of an apparatus, provided according to the embodiments of the present disclosure.

FIG. 15 is a schematic block diagram of a communication system, provided according to the embodiments of the present disclosure.

### DETAILED DESCRIPTION

The technical solutions in the embodiments of the present disclosure will be described in conjunction with the drawings in the embodiments of the present disclosure, and obviously, the described embodiments are a part of the embodiments of the present disclosure, but not all of the embodiments. For the embodiments of the present disclosure, all other embodiments obtained by the ordinary skilled in the art belong to the protection scope of the present disclosure.

The technical solutions of the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), an internet of things (IoT), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of communication technology, the mobile communication system will not only support traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc., and the embodiments of the present disclosure may also be applied to these communication systems.

In some embodiments, the communication system in the embodiments of the present disclosure may be applied to a carrier aggregation (CA) scenario, the communication system may also be applied to a dual connectivity (DC) scenario, and may also be applied to a standalone (SA) network deployment scenario, or be applied to non-standalone (NSA) network deployment scenario.

In some embodiments, the communication system in the embodiments of the present disclosure may be applied to an unlicensed spectrum, where the unlicensed spectrum may also be considered as a shared spectrum. Alternatively, the communication system in the embodiments of the present disclosure may also be applied to a licensed spectrum, where the licensed spectrum may also be considered as an unshared spectrum.

In some embodiments, the communication system in the embodiments of the present disclosure may be applied to an FRI frequency band (corresponding to a frequency band range of 410 MHz to 7.125 GHZ). Alternatively, the communication system may also be applied to an FR2 frequency band (corresponding to a frequency band range of 24.25 GHZ to 52.6 GHZ). Alternatively, the communication system may also be applied to a new frequency band, such as a high frequency band corresponding to a frequency band range of 52.6 GHz to 71 GHz or corresponding to a frequency band range of 71 GHz to 114.25 GHZ.

The embodiments of the present disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present disclosure, the terminal device may be deployed on land, which includes indoor or outdoor, in handheld, worn, or vehicle-mounted; the terminal device may also be deployed on water (e.g., on a ship, etc.); the terminal device may also be deployed in the air (e.g., on an airplane, a balloon, a satellite, etc.).

In the embodiments of the present disclosure, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), etc.

As an example but not a limitation, in the embodiments of the present disclosure, the terminal device may also be a wearable device. The wearable device, which may also be referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes, for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA. The network device may also be a base station (NodeB, NB) in the WCDMA, or may also be an evolutionary base station (Evolutionary Node B, cNB or eNodeB) in the LTE, or a relay station or an access point, or a vehicle-mounted device, a wearable device, and a network device or a base station (gNB) in an NR network, or a network device in the PLMN network evolved in the future or a network device in the NTN network, etc.

As an example but not a limitation, in the embodiments of the present disclosure, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station provided on land, water, and other places.

In the embodiments of the present disclosure, the network device may provide a service for a cell, and the terminal device communicates with the network device through a transmission resource (such as a frequency domain resource, or a frequency spectrum resource) used by the cell. The cell may be a cell corresponding to the network device (e.g., the base station), the cell may belong to a macro base station or may also belong to a base station corresponding to a small cell, and the small cell herein may include: a metro cell, a micro cell, a pico cell, a femto cell, etc., these small cells have characteristics of small coverage range and low transmission power, which are applicable for providing a data transmission service with a high speed.

For example, the communication system 100 applied by the embodiments of the present disclosure is shown in FIG. 1. The communication system 100 may include a source terminal 110, a destination terminal 120, and a relay terminal 130. The relay terminal 130 may provide communication coverage for a specific geographical area and may communicate with a terminal device located within the coverage area.

In some embodiments, the communication system 100 may also include other network entities such as a network controller and a mobility management entity, etc., the present disclosure is not limited thereto.

It should be understood that, in the embodiments of the present disclosure, a device with a communication function in the network/system may be referred to as a communication device. Considering the communication system 100 shown in FIG. 1 as an example, the communication device may include a source terminal 110, a destination terminal 120, and a relay terminal 130 with communication functions. The communication device may also include other devices in the communication system 100, such as a network controller, a mobile management entity, and other network entities, which are not limited to the embodiments of the present disclosure.

It should be understood that the terms “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the present disclosure may relate to a first communication device and a second communication device, and the first communication device may be a terminal device, such as a mobile phone, a machine facility, a customer premise equipment (CPE), an industrial device, a vehicle, etc.; the second communication device may be a counterpart communication device of the first communication device, such as a terminal device, a network device, a machine facility, a CPE, a mobile phone, an industrial device, a vehicle, etc. In the embodiments of the present disclosure, the first communication device may be a first terminal, and the second communication device may be a relay terminal or a second terminal. Alternatively, the first communication device may be a second terminal, and the second communication device may be a first terminal or a relay terminal. Alternatively, the first communication device may be a relay terminal, and the second communication device may be a first terminal or a second terminal.

The terms used in the implementation parts of the present disclosure are only used to explain specific embodiments of the present disclosure and are not intended to limit the present disclosure. The terms “first”, “second”, “third” and “fourth” etc., in the description, claims and drawings of the present disclosure are used to distinguish different objects rather than to describe a specific order. In addition, the terms “including” and “having” and any derivations thereof are intended to cover non-exclusive inclusion.

It should be understood that the “indication” mentioned in the embodiments of the present disclosure may be a direct indication, may also be an indirect indication, or may also represent having an association relationship. For example, A indicates B, which may mean that A directly indicates B, for example, B may be acquired by A. A indicating B may also mean that A indirectly indicating B, for example, A indicates C, and B may be acquired by C. Alternatively, A indicating B may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the present disclosure, “predefined” or “preconfigured” may be implemented by pre-saving corresponding codes, tables, or other manners that may be used for indicating related information, in the device (for example, including the terminal device and the network device), and the present disclosure does not limit its specific implementation. For example, the predefined may refer to what is defined in a protocol.

In the embodiments of the present disclosure, the “protocol” may refer to a standard protocol in the communication field, for example, it may be an evolution of an existing LTE protocol, an NR protocol, a Wi-Fi protocol, or other communication system related protocols and the present disclosure does not limit the type of protocol.

In order to facilitate the understanding of technical solutions of the embodiments of the present disclosure, the technical solutions of the present disclosure are described in detail below through specific embodiments. The following related arts, as optional solutions, may be randomly combined with the technical solutions of the embodiments of the present disclosure, which all belong to the protection scope of the embodiments of the present disclosure. The embodiments of the present disclosure include at least some of the following contents.

In some scenarios, a layer 2-based UE-to-Network relay terminal (Relay UE) is introduced, and the UE-to-Network relay terminal may be directly connected to a network. Exemplarily, a remote terminal is connected to an access network (e.g., gNB) and a core network (CN) (e.g., 5G Core Network (5GC)) through a UE-to-Network relay terminal.

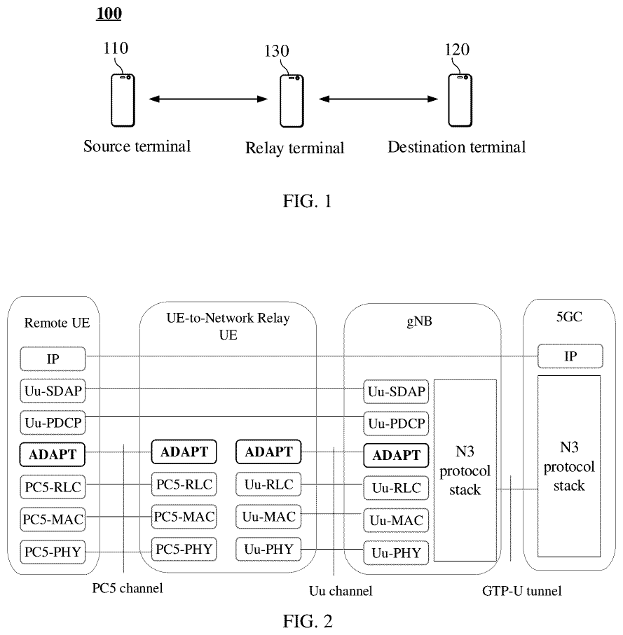

FIG. 2 shows a schematic diagram of a transmission protocol stack in a 5G system, specifically involving a remote UE, a layer 2 UE-to-Network relay UE, a gNB, and a 5GC. As shown in FIG. 2, the remote UE may include the following layers: Internet Protocol (IP), Uu-Service Data Adaptation Protocol (SDAP), Uu-Packet Data Convergence Protocol (PDCP), PC5-Radio Link Control (RLC), PC5-Media Access Control (MAC), and PC5-Physics (PHY). The UE-to-Network relay terminal may include the following layers: Adaptation (ADAPT), PC5-RLC, PC5-MAC, PC5-PHY, Uu-RLC, Uu-MAC, and Uu-PHY. The gNB may include the following layers: Uu-SDAP, Uu-PDCP, ADAPT, Uu-RLC, Uu-MAC, Uu-PHY, N3 protocol stack. 5GC may include the following layers: IP, and N3 protocol stack.

As shown in FIG. 2, the adaptation (ADAPT) layer of the relay UE is set on a control plane and user plane RLC layer of a PC5 interface between a remote UE and a relay UE, and the adaptation (ADAPT) layer of the relay UE is set on a control plane and user plane RLC layer of a Uu interface between a relay UE and a gNB. Uu-SDAP, Uu-PDCP, and Radio Resource Control (RRC) are terminated between the remote UE and the gNB, RLC, MAC, and PHY are terminated in each link (including a link between the remote UE and the relay UE, and a link between the relay UE and the gNB).

In some embodiments, a link between the relay UE and the network may be referred to as a Uu link, a Uu path, a direct link between the remote UE and the network may also be referred to as a Uu link, a Uu path, and a link between the remote UE and the relay UE may be referred to as a PC5 link, a PC5 path.

For an uplink of L2 UE-to-Network relay UE:
the adaptation layer of the relay terminal supports an uplink bearer mapping between access PC5 RLC channels, and the access PC5 RLC channel is used to perform transmission on the Uu path between the relay UE and the network and egresses the Uu channel. For an uplink relay service, different end-to-end bearers (e.g., a signaling radio bearer (SRB), a data radio bearer (DRB)) of a same remote UE and/or different remote UEs may perform N:1 mapping and data multiplexing on a Uu RLC channel.

The adaptation layer of the relay UE includes identification information of the remote terminal of the uplink service to be relayed and identification information of the radio bearer of the remote terminal, so that the gNB may associate a received data packet of a specific Packet Data Convergence Protocol (PDCP) entity associated with the radio bearer of the remote terminal.

For a downlink of L2 UE-to-Network relay UE:
the adaptation layer of the relay UE may be used to support a downlink bearer mapping at the gNB to map the end-to-end radio bearer (e.g., an SRB, a DRB) of the remote terminal to a Uu RLC channel through the Uu path between the relay UE and the network. The adaptation layer of the relay UE may be used to support a plurality of end-to-end radio bearers (e.g., an SRB, a DRB) of a remote UE and/or different remote UEs and a downlink N:1 bearer mapping and data multiplexing on a Uu RLC channel on a Uu path between the relay UE and the network.

The adaptation layer of the relay UE includes identification information of the remote terminal of a downlink service to be relayed. The identification information of the radio bearer of the remote terminal and the identification information of the remote terminal needs to be placed in the adaptation layer of the relay UE through the gNB, so that the relay UE can map the data packet received from the radio bearer of the remote terminal to the PC5 RLC channel associated with the radio bearer.

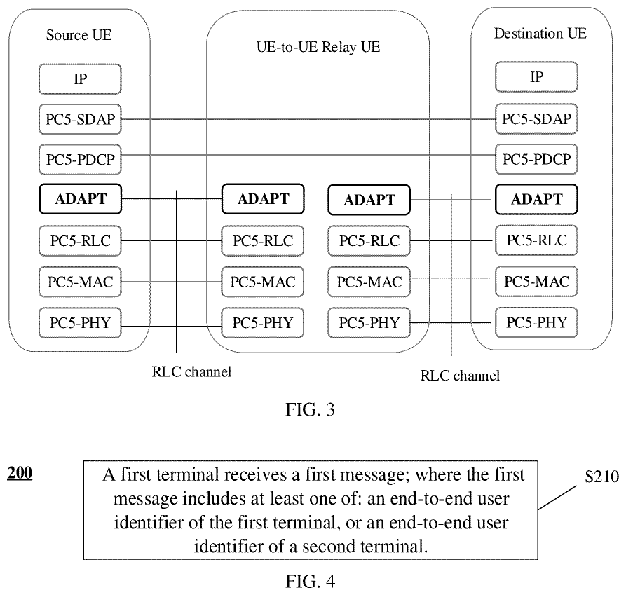

In some scenarios, a UE-to-UE relay is introduced. As shown in FIG. 3, a source UE communicates with a destination terminal through a relay UE. In a terminal-to-terminal relay (UE-to-UE Relay) communication, the adaptation (ADAPT) layer is located above the PC5-RLC layer. For the source terminal and the destination terminal, the adaptation (ADAPT) layer is located between the PC5-RLC layer and the PC5-PDCP. In the adaptation (ADAPT) layer, the user identifier of the source terminal and/or the destination terminal needs to be contained for end-to-end transmission. The problem of how to perform end-to-end identifier allocation is solved before data transmission based on the above protocol stack can be performed.

Based on the above problem, the present disclosure provides a relay communication solution. In UE-to-UE relay communication, a scheme for allocating end-to-end user identifiers of a source terminal and/or a destination terminal is designed to optimize UE-to-UE relay communication.

The embodiments of the present disclosure provide a relay communication method, which is applied to a first terminal, where a relay connection is established between the first terminal and a second terminal through a relay terminal, and the method includes:
receiving, by the first terminal, a first message; where the first message includes at least one of the following: an end-to-end user identifier of the first terminal, or an end-to-end user identifier of the second terminal.

In some embodiments, the method further includes:
sending, by the first terminal, a second message; where the second message is used to instruct the first terminal to accept the end-to-end user identifier(s) carried in the first message, or the second message is used to instruct the first terminal to reject the end-to-end user identifier(s) carried in the first message.

In some embodiments, in a case where there is a conflict between the end-to-end user identifier(s) carried in the first message and a local configuration of the first terminal, the second message is used to instruct the first terminal to reject the end-to-end user identifier carried in the first message; or in a case where the local configuration of the first terminal has an end-to-end user identifier that is identical to the end-to-end user identifier(s) carried in the first message, the second message is used to instruct the first terminal to reject the end-to-end user identifier(s) carried in the first message.

In some embodiments, in a case where the second message is used to instruct the first terminal to reject the end-to-end user identifier(s) carried in the first message, the method further includes:
receiving, by the first terminal, a third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control element (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following: a Proximity-based Services (ProSe) direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information.

In some embodiments, the end-to-end user identifier(s) is/are equivalent to a layer 2 identifier or a media access control (MAC) layer identifier; or the end-to-end user identifier(s) is/are not equivalent to the layer 2 identifier or the MAC layer identifier.

The embodiments of the present disclosure provide a relay communication method, which is applied to a second terminal, where a relay connection is established between the second terminal and a first terminal through a relay terminal, and the method includes:
sending, by the second terminal, a first message; where the first message includes at least one of the following: an end-to-end user identifier of the first terminal, or an end-to-end user identifier of the second terminal.

In some embodiments, the method further includes:
receiving, by the second terminal, a second message; where the second message is used to instruct the first terminal to accept the end-to-end user identifier(s) carried in the first message, or the second message is used to instruct the first terminal to reject the end-to-end user identifier(s) carried in the first message.

In some embodiments, in a case where there is a conflict between the end-to-end user identifier(s) carried in the first message and a local configuration of the first terminal, the second message is used to instruct the first terminal to reject the end-to-end user identifier(s) carried in the first message; or in a case where the local configuration of the first terminal has an end-to-end user identifier that is identical to the end-to-end user identifier(s) carried in the first message, the second message is used to instruct the first terminal to reject the end-to-end user identifier(s) carried in the first message.

In some embodiments, in a case where the second message is used to instruct the first terminal to reject the end-to-end user identifier(s) carried in the first message, the method further includes:
sending, by the second terminal, a third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control unit (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following: a ProSe direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information.

In some embodiments, the end-to-end user identifier(s) is/are equivalent to a layer 2 identifier or a media access control (MAC) layer identifier; or the end-to-end user identifier(s) is/are not equivalent to the layer 2 identifier or the MAC layer identifier.

The embodiments of the present disclosure provide a relay communication method, which is applied to a relay terminal, where a relay connection is established between a first terminal and a second terminal through the relay terminal, and the method includes:
sending, by the relay terminal, a first message, or forwarding, by the relay terminal, the first message; where the first message includes at least one of the following: an end-to-end user identifier of the first terminal, or an end-to-end user identifier of the second terminal.

In some embodiments, the method further includes:
receiving, by the relay terminal, a second message, or forwarding, by the relay terminal, the second message; where the second message is used to instruct the first terminal to accept the end-to-end user identifier(s) carried in the first message, or the second message is used to instruct the first terminal to reject the end-to-end user identifier(s) carried in the first message.

In some embodiments, in a case where there is a conflict between the end-to-end user identifier(s) carried in the first message and a local configuration of the first terminal, the second message is used to instruct the first terminal to reject the end-to-end user identifier(s) carried in the first message; or in a case where the local configuration of the first terminal has an end-to-end user identifier that is identical to the end-to-end user identifier(s) carried in the first message, the second message is used to instruct the first terminal to reject the end-to-end user identifier(s) carried in the first message.

In some embodiments, in a case where the second message is used to instruct the first terminal to reject the end-to-end user identifier(s) carried in the first message, the method further includes:
sending, by the relay terminal, a third message, or forwarding, by the relay terminal, the third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control element (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following: a Proximity-based Services (ProSc) direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information.

In some embodiments, the end-to-end user identifier(s) is/are equivalent to a layer 2 identifier or a media access control (MAC) layer identifier; or the end-to-end user identifier(s) is/are not equivalent to the layer 2 identifier or the MAC layer identifier.

The technical solutions of the present disclosure are described in detail below by specific embodiments.

FIG. 4 is a schematic flow chart of a relay communication method 200 according to the embodiments of the present disclosure. As shown in FIG. 4, the method is applied to a first terminal, where a relay connection is established between the first terminal and a second terminal through a relay terminal. The relay communication method 200 may include at least part of the following contents.

S210, the first terminal receives a first message; where the first message includes at least one of the following: an end-to-end user identifier of the first terminal, or an end-to-end user identifier of the second terminal.

In the embodiments of the present disclosure, the first terminal acquires the end-to-end user identifier of the first terminal and/or the end-to-end user identifier of the second terminal through a first message, so that the first terminal may apply the end-to-end user identifier of the first terminal and/or the end-to-end user identifier of the second terminal in its adaptation layers for end-to-end transmission, thereby optimizing the UE-to-UE relay communication.

In some embodiments, the end-to-end user identifier may be equivalent to a layer 2 identifier or an MAC layer identifier.

In some embodiments, the end-to-end user identifier may not be equivalent to the layer 2 identifier or the MAC layer identifier.

In some embodiments, the above S210 may also be performed by a relay terminal, that is, the relay terminal receives a first message; where the first message includes at least one of the following: an end-to-end user identifier of the first terminal, or an end-to-end user identifier of the second terminal.

In some embodiments, the first terminal is a source terminal and the second terminal is a destination terminal. Alternatively, the first terminal is a destination terminal and the second terminal is a source terminal.

In some embodiments, the first message only contains the end-to-end user identifier of the first terminal. In this case, the first terminal may allocate the end-to-end user identifier of the second terminal.

In some embodiments, the first message only contains the end-to-end user identifier of the second terminal. In this case, the first terminal may allocate the end-to-end user identifier of the first terminal.

In some embodiments, the first message is sent by a relay terminal.

For example, the first terminal receives a first message sent by the relay terminal. That is, the relay terminal may allocate the end-to-end user identifier of the first terminal and/or the end-to-end user identifier of the second terminal.

For another example, the first terminal receives the first message generated and sent by the relay device based on a message sent by the second terminal, where the message sent by the second terminal may contain part or all of the contents contained in the first message. That is, the relay terminal may allocate the end-to-end user identifier of the first terminal and/or the end-to-end user identifier of the second terminal based on the message sent by the second terminal, or the second terminal allocates the end-to-end user identifier of the first terminal and/or the end-to-end user identifier of the second terminal.

In some embodiments, the first message is sent by the second terminal, and is forwarded by the relay terminal. For example, the first terminal receives the first message sent by the second terminal and forwarded by the relay terminal. That is, the second terminal may allocate the end-to-end user identifier of the first terminal and/or the end-to-end user identifier of the second terminal.

For example, exemplarily, the first message is a message used to configure an end-to-end identifier.

In some embodiments, the first terminal sends a second message, where the second message is used to instruct the first terminal to accept the end-to-end user identifier carried in the first message, or the second message is used to instruct the first terminal to reject the end-to-end user identifier carried in the first message.

For example, exemplarily, in a case where the first message is sent by the relay terminal, the relay terminal receives the second message.

For another example, exemplarily, in a case where the first message is sent by the second terminal and forwarded by the relay terminal, the relay terminal receives the second message and forwards the second message to the second terminal.

In some embodiments, in a case where there is a conflict between the end-to-end user identifier carried in the first message and a local configuration of the first terminal, the second message is used to instruct the first terminal to reject the end-to-end user identifier carried in the first message.

In some embodiments, in a case where the local configuration of the first terminal has an end-to-end user identifier that is identical to the end-to-end user identifier carried in the first message, the second message is used to instruct the first terminal to reject the end-to-end user identifier carried in the first message.

In some embodiments, in a case where the second message is used to instruct the first terminal to reject the end-to-end user identifier carried in the first message, the first terminal receives a third message; where the third message includes at least one of the following: a reallocated end-to-end user identifier of the first terminal, or a reallocated end-to-end user identifier of the second terminal.

In some embodiments, the third message only contains an end-to-end user identifier of the first terminal. In this case, the first terminal may reallocate the end-to-end user identifier of the second terminal.

In some embodiments, the third message only contains an end-to-end user identifier of the second terminal. In this case, the first terminal may reallocate the end-to-end user identifier of the first terminal.

In some embodiments, the third message is sent by a relay terminal.

For example, the first terminal receives a third message sent by the relay terminal. That is, the relay terminal may reallocate the end-to-end user identifier of the first terminal and/or the end-to-end user identifier of the second terminal.

For another example, the first terminal receives the third message generated and sent by the relay device based on a message sent by the second terminal, where the message sent by the second terminal may contain part or all of the contents contained in the third message. That is, the relay terminal may reallocate the end-to-end user identifier of the first terminal and/or the end-to-end user identifier of the second terminal based on the message sent by the second terminal, or the second terminal reallocates the end-to-end user identifier of the first terminal and/or the end-to-end user identifier of the second terminal.

In some embodiments, the third message is sent by the second terminal, and is forwarded by the relay terminal. For example, the first terminal receives the third message sent by the second terminal and forwarded by the relay terminal. That is, the second terminal may reallocate the end-to-end user identifier of the first terminal and/or the end-to-end user identifier of the second terminal.

In some embodiments, the end-to-end user identifier described in the present disclosure may be equivalent to a layer 2 identifier or an MAC layer identifier. Alternatively, the end-to-end user identifier described in the present disclosure may not be equivalent to the layer 2 identifier or the MAC layer identifier.

In some embodiments, the first message includes one of the following: a PC-S message, a discovery message, a PC5-RRC message, a media access control-control unit (MAC-CE), or an adaptation layer control (Control) protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

It should be noted that types of different messages in the above first message, second message, and third message may be the same or different from each other, and the present disclosure is not limited thereto.

In some embodiments, the PC-S message includes one of the following: a Proximity-based Services (ProSe) direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, and a ProSe direct link authentication failure. The PC-S message may also be a new PC-S message, the present disclosure is not limited thereto.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, and relay discovery additional information. The discovery message may also be a new discovery message, the present disclosure is not limited thereto.

Therefore, in the embodiments of the present disclosure, in the UE-to-UE relay communication, the relay terminal allocates the end-to-end user identifier of the first terminal and the end-to-end user identifier of the second terminal to the first terminal, or the second terminal allocates the end-to-end user identifier of the first terminal and the end-to-end user identifier of the second terminal to the first terminal, thereby optimizing the UE-to-UE relay communication.

The technical solutions of the present disclosure are described in detail below through Embodiment 1 to Embodiment 3.

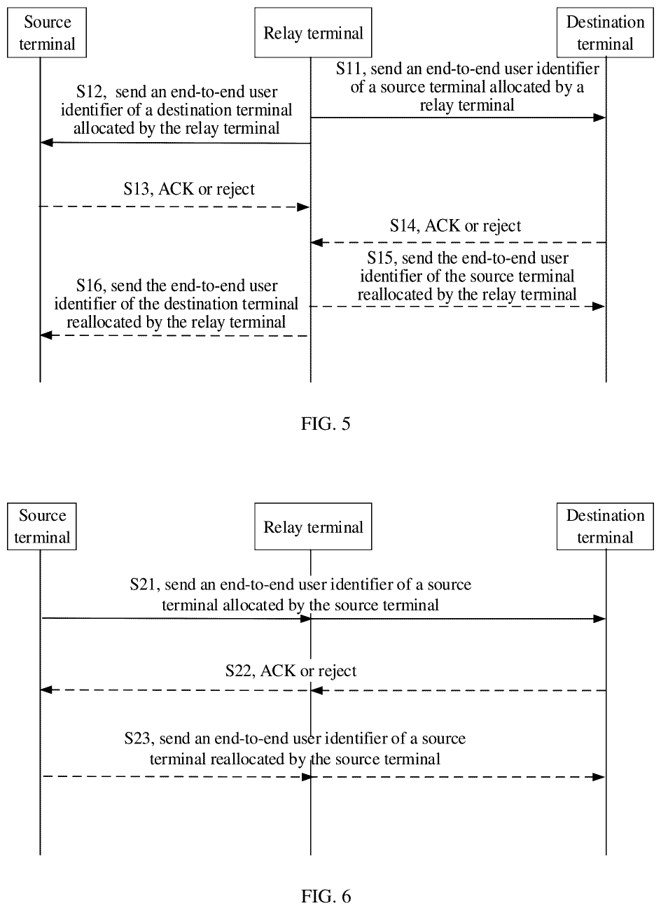

Embodiment 1, the relay terminal performs a configuration of an end-to-end user identifier, as shown in FIG. 5, and the specific process may include some or all of step S11 to step S16.
S11, a relay terminal sends an end-to-end user identifier of a source terminal allocated by a relay terminal to a destination terminal, where S11 may be implemented by one of the following: a PC-S message, a discovery message, a PC5-RRC message, a MAC-CE, or an adaptation layer control PDU.
S12, the relay terminal sends an end-to-end user identifier of a destination terminal allocated by the relay terminal to a source terminal, where S12 may be implemented by one of the following: a PC-S message, a discovery message, a PC5-RRC message, a MAC-CE, or an adaptation layer control PDU.
S13, the source terminal sends an ACK message (ACK) or a reject message (optional) to the relay terminal, where the ACK message is used to indicate that the source terminal accepts the end-to-end user identifier of the destination terminal sent in S12, and the reject message is used to indicate that the source terminal rejects the end-to-end user identifier of the destination terminal sent in S12, and the reject herein may be due to other conflicting/repeated (identical) end-to-end user identifiers locally in the source terminal; where S13 may be implemented by one of the following: a PC-S message, a discovery message, a PC5-RRC message, a MAC-CE, or an adaptation layer control PDU.
S14, the destination terminal sends an ACK message or a reject message (optional) to the relay terminal, where the ACK message is used to indicate that the destination terminal accepts the end-to-end user identifier of the source terminal sent in S11, and the reject message is used to indicate that the destination terminal rejects the end-to-end user identifier of the source terminal sent in S11, and the reject herein may be due to other conflicting/repeated end-to-end user identifiers locally in the destination terminal; where S14 may be implemented by one of the following: a PC-S message, a discovery message, a PC5-RRC message, a MAC-CE, or an adaptation layer control PDU.
S15, the relay terminal sends the end-to-end user identifier (optional) of the source terminal reallocated by the relay terminal to the destination terminal, where S15 may be implemented by one of the following: a PC-S message, a discovery message, a PC5-RRC message, a MAC-CE, or an adaptation layer control PDU.
S16, the relay terminal sends the end-to-end user identifier (optional) of the destination terminal reallocated by the relay terminal to the source terminal, where S16 may be implemented by one of the following: a PC-S message, a discovery message, a PC5-RRC message, a MAC-CE, or an adaptation layer control PDU.

It should be noted that the above S11 and S12 may be performed simultaneously or in sequence, S11 may be performed first and S12 may be performed later, or S12 may be performed first and S11 may be performed later, the present disclosure is not limited thereto. The types of messages corresponding to the different steps in the above S11 to S16 may be the same or different from each other, the present disclosure is not limited thereto.

Embodiment 2, a remote terminal (a source terminal and/or a destination terminal) performs a configuration of its own end-to-end user identifier, that is, Embodiment 2 may ultimately achieve the source terminal allocating its own end-to-end user identifier and the destination terminal allocating its own end-to-end user identifier. The following description considers a configuration of its own end-to-end user identifier of the source terminal as an example. The destination terminal may refer to the description of the source terminal, which will not be repeated herein. Exemplarily, as shown in FIG. 6, the source terminal configures the end-to-end user identifier of the source terminal to the relay terminal and/or the destination terminal. The specific process may include part or all of steps S21 to S23.
S21, a source terminal sends an allocated end-to-end user identifier of the source terminal to a relay terminal and/or a destination terminal; where a message from the relay terminal to the destination terminal may be a message forwarded from the source terminal without processing above an access layer; or, a message from the relay terminal to the destination terminal may be a message newly generated after receiving a message from the source terminal and processing above the access layer; where S21 may be implemented by one of the following: a PC-S message, a discovery message, a PC5-RRC message, a MAC-CE, or an adaptation layer control PDU.
S22, the relay terminal and/or the destination terminal acknowledges (ACKs)/rejects (rejects) an end-to-end user identifier configuration of the source terminal (i.e., the end-to-end user identifier of the source terminal) in the above S21, and the reject herein may be due to the relay terminal and/or the destination terminal having other conflicting/repeated end-to-end user identifiers locally; where a message from the relay terminal to the source terminal may be a message forwarded from the destination terminal without processing above the access layer; or, a message from the relay terminal to the source terminal may be a newly generated message after receiving a message from the destination terminal and processing above the access layer; where S22 may be implemented by one of the following: a PC-S message, a discovery message, a PC5-RRC message, a MAC-CE, or an adaptation layer control PDU.
S23, the source terminal sends a reallocated end-to-end user identifier of the source terminal to the relay terminal and/or destination terminal; where the message from the relay terminal to the destination terminal may be a message forwarded from the source terminal without processing above the access layer; or, a message from the relay terminal to the destination terminal may be a message newly generated after receiving a message from the source terminal and processing above the access layer; where S23 may be implemented by one of the following: a PC-S message, a discovery message, a PC5-RRC message, a MAC-CE, or an adaptation layer control PDU.

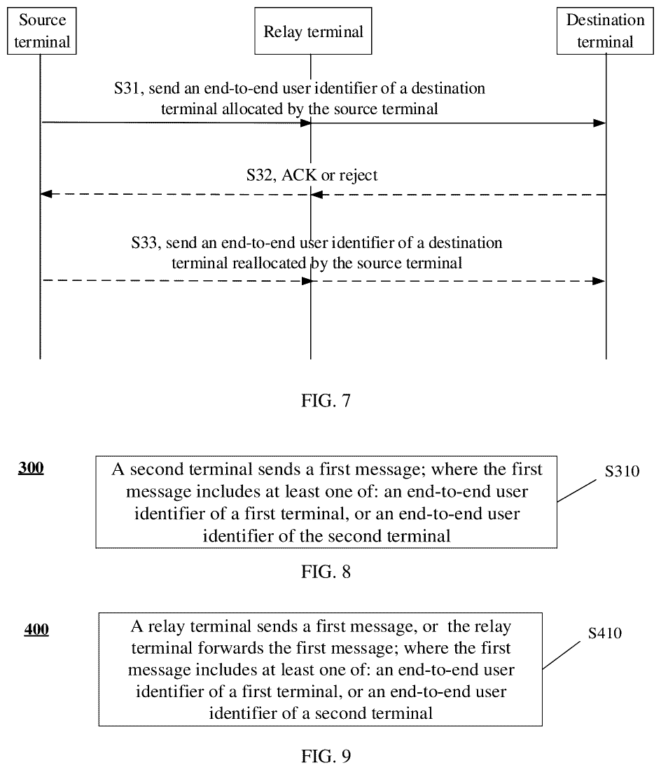

Embodiment 3, a remote terminal (a source terminal and/or a destination terminal) performs a configuration of a counterpart end-to-end user identifier, that is, Embodiment 3 may ultimately achieve the allocation of the end-to-end user identifier of the destination terminal to the source terminal, and allocation of the end-to-end user identifier of the source terminal to the destination terminal. The following description considers a configuration of the end-to-end user identifier of the destination terminal using the source terminal as an example. The destination terminal may refer to the description of the source terminal, which will not be repeated herein. Exemplarily, as shown in FIG. 7, the source terminal configures the end-to-end user identifier of the destination terminal to the relay terminal and/or the destination terminal. The specific process may include part or all of the steps S31 to S33.
S31, a source terminal sends an allocated end-to-end user identifier of a destination terminal to a relay terminal and/or a destination terminal; where a message from the relay terminal to the destination terminal may be a message forwarded from the source terminal without processing above an access layer; or, a message from the relay terminal to the destination terminal may be a message newly generated after receiving a message from the source terminal and processing above the access layer; where S31 may be implemented by one of the following: a PC-S message, a discovery message, a PC5-RRC message, a MAC-CE, or an adaptation layer control PDU.
S32, the relay terminal and/or the destination terminal acknowledges (ACKs)/rejects (reject) an end-to-end user identifier configuration of the source terminal (i.e., the end-to-end user identifier of the destination terminal) in the above S31, and the reject herein may be due to the relay terminal and/or the destination terminal having other conflicting/repeated end-to-end user identifiers locally; where the message from the relay terminal to the source terminal may be the message forwarded from the destination terminal without processing above the access layer; or, the message from the relay terminal to the source terminal may be a newly generated message after receiving the message from the destination terminal and processing above the access layer; where S32 may be implemented by one of the following: the PC-S message, the discovery message, the PC5-RRC message, the MAC-CE, or the adaptation layer control PDU.
S33, the source terminal sends a reallocated end-to-end user identifier of the destination terminal to the relay terminal and/or destination terminal; where the message from the relay terminal to the destination terminal may be a message forwarded from the source terminal without processing above the access layer; or, the message from the relay terminal to the destination terminal may be the message newly generated after receiving the message from the source terminal and processing above the access layer; where S33 may be implemented by one of the following: the PC-S message, the discovery message, the PC5-RRC message, the MAC-CE, or the adaptation layer control PDU.

It should be noted that allocating the source terminal's own end-to-end user identifier and an end-to-end user identifier of the destination terminal to the source terminal, or, allocating the destination terminal's own end-to-end user identifier and an end-to-end user identifier of the source terminal to the destination terminal may ultimately be achieved in the above Embodiment 2 and Embodiment 3.

The first terminal side embodiments of the present disclosure are described in detail above with reference to FIG. 4 to FIG. 7. The second terminal side embodiments of the present disclosure are described in detail below with reference to FIG. 8. It should be understood that the second terminal side embodiments and the first terminal side embodiments correspond to cach other, and similar descriptions may refer to the first terminal side embodiments.

FIG. 8 is a schematic flow chart of a relay communication method 300 according to the embodiments of the present disclosure. As shown in FIG. 8, the method is applied to a second terminal, where a relay connection is established between the second terminal and a first terminal through a relay terminal. The relay communication method 300 may include at least part of the following contents:
S310, sending, by the second terminal, a first message; where the first message includes at least one of the following: an end-to-end user identifier of the first terminal, or an end-to-end user identifier of the second terminal.

In the embodiments of the present disclosure, the second terminal sends the end-to-end user identifier of the first terminal and/or the end-to-end user identifier of the second terminal through the first message, so that the first terminal and/or the relay terminal may apply the end-to-end user identifier of the first terminal and/or the end-to-end user identifier of the second terminal in its adaptation layers for end-to-end transmission, thereby optimizing the UE-to-UE relay communication.

In some embodiments, the end-to-end user identifier may be equivalent to a layer 2 identifier or an MAC layer identifier.

In some embodiments, the end-to-end user identifier may not be equivalent to the layer 2 identifier or the MAC layer identifier.

In some embodiments, the first terminal is a source terminal and the second terminal is a destination terminal. Alternatively, the first terminal is a destination terminal and the second terminal is a source terminal.

In some embodiments, the first terminal receives the first message, and/or the relay terminal receives the first message.

For example, the first terminal receives the first message sent by the second terminal and forwarded by the relay terminal. That is, the second terminal may allocate the end-to-end user identifier of the first terminal and/or the end-to-end user identifier of the second terminal.

For example, exemplarily, the first message is a message used to configure an end-to-end identifier.

In some embodiments, the second terminal receives a second message; where the second message is used to instruct the first terminal to accept the end-to-end user identifier carried in the first message, or the second message is used to instruct the first terminal to reject the end-to-end user identifier carried in the first message.

For example, exemplarily, the second terminal receives the second message sent by a first device and forwarded by the relay device.

For another example, exemplarily, the second terminal receives the second message generated and sent by the relay device based on the message sent by the first terminal.

In some embodiments, in a case where there is a conflict between the end-to-end user identifier carried in the first message and a local configuration of the first terminal, the second message is used to instruct the first terminal to reject the end-to-end user identifier carried in the first message.

In some embodiments, in a case where the local configuration of the first terminal has an end-to-end user identifier that is identical to the end-to-end user identifier carried in the first message, the second message is used to instruct the first terminal to reject the end-to-end user identifier carried in the first message.

In some embodiments, in a case where the second message is used to instruct the first terminal to reject the end-to-end user identifier carried in the first message, the second terminal sends a third message; where the third message includes at least one of the following: a reallocated end-to-end user identifier of the first terminal, or a reallocated end-to-end user identifier of the second terminal.

In some embodiments, the first terminal receives the third message, and/or the relay terminal receives the third message.

In some embodiments, the end-to-end user identifier described in the present disclosure may be equivalent to a layer 2 identifier or an MAC layer identifier. Alternatively, the end-to-end user identifier described in the present disclosure may not be equivalent to the layer 2 identifier or the MAC layer identifier.

In some embodiments, the first message includes one of the following: a PC-S message, a discovery message, a PC5-RRC message, a MAC-CE, or an adaptation layer control PDU.

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

It should be noted that types of different messages in the above first message, second message, and third message may be the same or different from each other, and the present disclosure is not limited thereto.

In some embodiments, the PC-S message includes one of the following: a ProSe direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure. The PC-S message may also be a new PC-S message, the present disclosure is not limited thereto.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information. The discovery message may also be a new discovery message, the present disclosure is not limited thereto.

Therefore, in the embodiments of the present disclosure, in the UE-to-UE relay communication, the relay terminal allocates the end-to-end user identifier of the first terminal and the end-to-end user identifier of the second terminal to the first terminal. Alternatively, the second terminal allocates the end-to-end user identifier of the first terminal and the end-to-end user identifier of the second terminal to the first terminal, thereby optimizing the UE-to-UE relay communication.

The first terminal side embodiments of the present disclosure are described in detail above with reference to FIG. 4 to FIG. 7. The relay terminal side embodiments of the present disclosure are described in detail below with reference to FIG. 9. It should be understood that the relay terminal side embodiments and the first terminal side embodiments correspond to each other, and similar descriptions may refer to the first terminal side embodiments.

FIG. 9 is a schematic flow chart of a relay communication method 400 according to the embodiments of the present disclosure. As shown in FIG. 9, the method is applied to a relay terminal, where a relay connection is established between a first terminal and a second terminal through the relay terminal. The relay communication method 400 may include at least part of the following contents:
S410, sending, by the relay terminal, a first message, or forwarding, by the relay terminal, the first message; where the first message includes at least one of the following: an end-to-end user identifier of the first terminal, or an end-to-end user identifier of the second terminal.

For example, exemplarily, the first terminal and/or the second terminal receives the first message.

In some embodiments, the first terminal is a source terminal and the second terminal is a destination terminal. Alternatively, the first terminal is a destination terminal and the second terminal is a source terminal.

In some embodiments, the end-to-end user identifier may be equivalent to a layer 2 identifier or an MAC layer identifier.

In some embodiments, the end-to-end user identifier may not be equivalent to the layer 2 identifier or the MAC layer identifier.

In some embodiments, in a case where the relay terminal sends the first message to the first terminal and/or the second terminal, the relay terminal may allocate an end-to-end user identifier of the first terminal and/or an end-to-end user identifier of the second terminal.

In some embodiments, in a case where the relay terminal sends the first message to a first terminal, the relay device generates and sends the first message based on a message sent by the second terminal, where the message sent by the second terminal may contain part or all of the contents contained in the first message. That is, the relay terminal may allocate the end-to-end user identifier of the first terminal and/or the end-to-end user identifier of the second terminal based on the message sent by the second terminal, or the second terminal allocates the end-to-end user identifier of the first terminal and/or the end-to-end user identifier of the second terminal.

In some embodiments, the relay terminal receives a second message, or the relay terminal forwards the second message; where the second message is used to instruct the first terminal to accept the end-to-end user identifier carried in the first message, or the second message is used to instruct the first terminal to reject the end-to-end user identifier carried in the first message.

In some embodiments, in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an end-to-end user identifier that is identical to the end-to-end user identifier carried in the first message in the local configuration of the first terminal, the second message is used to instruct the first terminal to reject the end-to-end user identifier carried in the first message.

In some embodiments, in a case where the second message is used to indicate that the first terminal rejects the end-to-end user identifier carried in the first message, the relay terminal sends a third message, or the relay terminal forwards the third message; where the third message includes at least one of the following: a reallocated end-to-end user identifier of the first terminal, or a reallocated end-to-end user identifier of the second terminal.

In some embodiments, the first terminal and/or the second terminal receives the third message.

In some embodiments, the end-to-end user identifier described in the present disclosure may be equivalent to a layer 2 identifier or an MAC layer identifier. Alternatively, the end-to-end user identifier described in the present disclosure may not be equivalent to the layer 2 identifier or the MAC layer identifier.

In some embodiments, the first message includes one of the following: a PC-S message, a discovery message, a PC5-RRC message, a MAC-CE, or an adaptation layer control PDU.

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

It should be noted that types of different messages in the above first message, second message, and third message may be the same or different from each other, and the present disclosure is not limited thereto.

In some embodiments, the PC-S message includes one of the following: a ProSe direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure. The PC-S message may also be a new PC-S message, the present disclosure is not limited thereto.

In some embodiments, the discovery message includes one of the following: an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information. The discovery message may also be a new discovery message, the present disclosure is not limited thereto.

Therefore, in the embodiments of the present disclosure, in the UE-to-UE relay communication, the relay terminal allocates the end-to-end user identifier of the first terminal and the end-to-end user identifier of the second terminal to the first terminal, or the second terminal allocates the end-to-end user identifier of the first terminal and the end-to-end user identifier of the second terminal to the first terminal, thereby optimizing the UE-to-UE relay communication.

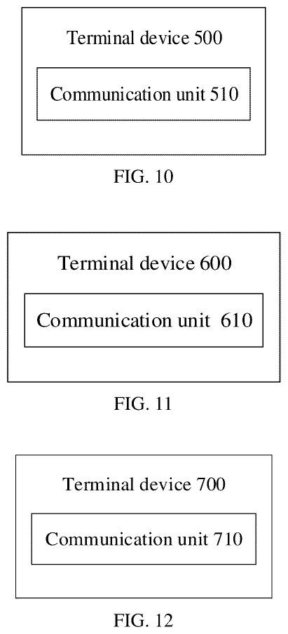

The method embodiments of the present disclosure are described in detail above with reference to FIG. 4 to FIG. 9, and apparatus embodiments of the present disclosure are described in detail below with reference to FIG. 10 to FIG. 12, and it should be understood that the apparatus embodiments and the method embodiments correspond to each other and the similar description may refer to the method embodiments.

FIG. 10 shows a schematic block diagram of a terminal device 500 according to the embodiments of the present disclosure. The terminal device 500 is a first terminal, where a relay connection is established between the first terminal and a second terminal through a relay terminal. As shown in FIG. 10, the terminal device 500 includes:
a communication unit 510, configured to receive a first message; where the first message includes at least one of the following: an end-to-end user identifier of the first terminal, or an end-to-end user identifier of the second terminal.

In some embodiments, the communication unit 510 is further configured to send a second message;
where the second message is used to instruct the first terminal to accept the end-to-end user identifier carried in the first message, or the second message is used to instruct the first terminal to reject the end-to-end user identifier carried in the first message.

In some embodiments, in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an end-to-end user identifier that is identical to the end-to-end user identifier carried in the first message in the local configuration of the first terminal, the second message is used to instruct the first terminal to reject the end-to-end user identifier carried in the first message.

In some embodiments, in a case where the second message is used to indicate that the first terminal rejects the end-to-end user identifier carried in the first message, the communication unit 510 is further configured to receive a third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control unit (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following:
a ProSe direct link establishment request, a ProSe direct link establishment accept, a ProSc direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following:
an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or relay discovery additional information.

In some embodiments, the end-to-end user identifier is equivalent to a layer 2 identifier or an MAC layer identifier; or
the end-to-end user identifier is not equivalent to the layer 2 identifier or the MAC layer identifier.

In some embodiments, the above communication unit may be a communication interface or a transceiver, or an input and output interface of a communication chip or a system-on-chip.

It should be understood that the terminal device 500 according to the embodiments of the present disclosure may correspond to the first terminal in the method embodiments of the present disclosure, and the above-mentioned and other operations and/or functions of each unit in the terminal device 500 are respectively for implementing the corresponding process of the first terminal in the method 200 shown in FIG. 4, which will not be repeated herein for the sake of brevity.

FIG. 11 shows a schematic block diagram of a terminal device 600 according to the embodiments of the present disclosure. The terminal device 600 is a second terminal, where a relay connection is established between the second terminal and a first terminal through a relay terminal. As shown in FIG. 11, the terminal device 600 includes:
a communication unit 610, configured to send a first message; where the first message includes at least one of the following: an end-to-end user identifier of the first terminal, or an end-to-end user identifier of the second terminal.

In some embodiments, the communication unit 610 is further configured to receive a second message;
where the second message is used to instruct the first terminal to accept the end-to-end user identifier carried in the first message, or the second message is used to instruct the first terminal to reject the end-to-end user identifier carried in the first message.

In some embodiments, in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an repeated end-to-end user identifier that is identical to the end-to-end user identifier carried in the first message, the second message is used to instruct the first terminal to reject the end-to-end user identifier carried in the first message.

In some embodiments, in a case where the second message is used to indicate that the first terminal rejects the end-to-end user identifier carried in the first message, the communication unit 610 is further configured to send a third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control unit (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following:
a ProSe direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following:
an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information.

In some embodiments, the end-to-end user identifier is equivalent to a layer 2 identifier or an MAC layer identifier; or
the end-to-end user identifier is not equivalent to the layer 2 identifier or the MAC layer identifier.

In some embodiments, the above communication unit may be a communication interface or a transceiver, or an input and output interface of a communication chip or a system-on-chip.

It should be understood that the terminal device 600 according to the embodiments of the present disclosure may correspond to the second terminal in the method embodiments of the present disclosure, and the above-mentioned and other operations and/or functions of each unit in the terminal device 600 are respectively for implementing the corresponding procedure of the second terminal in the method 300 shown in FIG. 8, which will not be repeated herein for the sake of brevity.

FIG. 12 shows a schematic block diagram of a terminal device 700 according to the embodiments of the present disclosure. The terminal device 700 is a relay terminal, where a relay connection is established between a first terminal and a second terminal through the relay terminal. As shown in FIG. 12, the terminal device 700 includes:
a communication unit 710, configured to send a first message, or the communication unit 710 is further configured to forward the first message; where the first message includes at least one of the following: an end-to-end user identifier of the first terminal, or an end-to-end user identifier of the second terminal.

In some embodiments, the communication unit 710 is further configured to receive a second message, or the communication unit 710 is further configured to forward the second message;
where the second message is used to instruct the first terminal to accept the end-to-end user identifier carried in the first message, or the second message is used to instruct the first terminal to reject the end-to-end user identifier carried in the first message.

In some embodiments, in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has a repeated end-to-end user identifier that is identical to the end-to-end user identifier carried in the first message, the second message is used to instruct the first terminal to reject the end-to-end user identifier carried in the first message.

In some embodiments, in a case where the second message is used to indicate that the first terminal rejects the end-to-end user identifier carried in the first message, the communication unit 710 is further configured to send a third message, or the communication unit 710 is further configured to forward the third message; where the third message includes at least one of the following: a reallocated end-to-end user identifier of the first terminal, or a reallocated end-to-end user identifier of the second terminal.

In some embodiments, the first message includes one of the following: a PC-S message, a discovery message, a PC5-radio resource control (RRC) message, a media access control-control unit (MAC-CE), or an adaptation layer control protocol data unit (PDU).

In some embodiments, the second message includes one of the following: a PC-S message, a discovery message, a PC5-RRC message, a MAC-CE, or an adaptation layer control PDU.

In some embodiments, the third message includes one of the following: a PC-S message, a discovery message, a PC5-RRC message, a MAC-CE, or an adaptation layer control PDU.

In some embodiments, the PC-S message includes one of the following:
a ProSe direct link establishment request, a ProSe direct link establishment accept, a ProSe direct link establishment reject, a ProSe direct link modification request, a ProSe direct link modification accept, a ProSe direct link authentication request, a ProSe direct link authentication response, a ProSe direct link authentication reject, a ProSe direct link security mode command, a ProSe direct link security mode complete, a ProSe direct link security mode reject, a ProSe direct link identifier update request, a ProSe direct link identifier update ack, a ProSe direct link identifier update reject, a ProSe direct link modification reject, or a ProSe direct link authentication failure.

In some embodiments, the discovery message includes one of the following:
an announcement message, a response message, a solicitation message, a UE-to-network relay discovery announcement, a UE-to-network relay discovery response, a UE-to-network relay discovery solicitation, a group member discovery announcement, a group member discovery response, a group member discovery solicitation, or Relay discovery additional information.

In some embodiments, the end-to-end user identifier is equivalent to a layer 2 identifier or an MAC layer identifier; or
the end-to-end user identifier is not equivalent to the layer 2 identifier or the MAC layer identifier.

In some embodiments, the above communication unit may be a communication interface or a transceiver. Alternatively, the above communication unit may be an input and output interface of a communication chip or a system-on-chip.

It should be understood that the terminal device 700 according to the embodiments of the present disclosure may correspond to the relay terminal in the method embodiments of the present disclosure, and the above-mentioned and other operations and/or functions of each unit in the terminal device 700 are respectively for implementing the corresponding process of the relay terminal in the method 400 shown in FIG. 9, which will not be repeated herein for the sake of brevity.

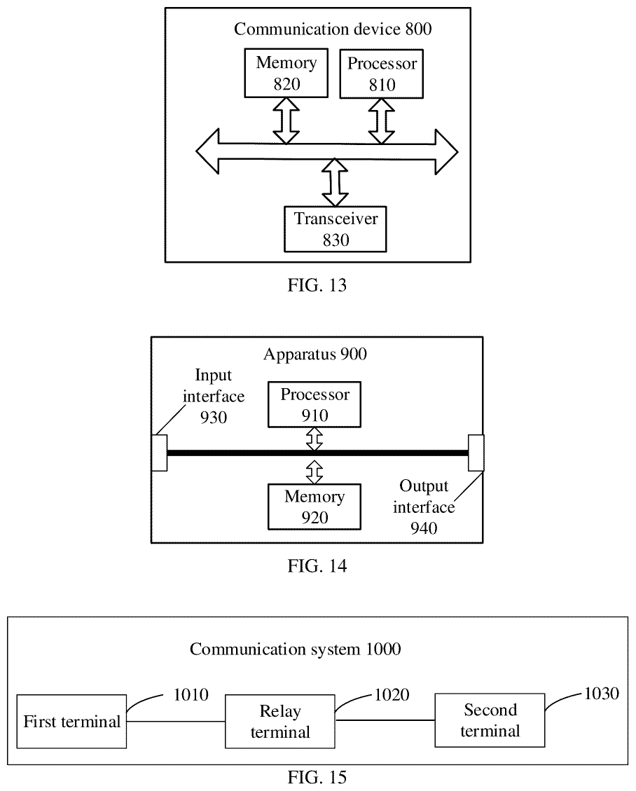

FIG. 13 is a schematic structural diagram of a communication device 800 provided by the embodiments of the present disclosure. The communication device 800 shown in FIG. 13 includes a processor 810, and the processor 810 may invoke a computer program from a memory and execute the memory to implement the method in the embodiments of the present disclosure.

In some embodiments, as shown in FIG. 13, the communication device 800 further includes a memory 820. Herein, the processor 810 may invoke and execute a computer program from the memory 820 to implement the method in the embodiments of the present disclosure.

Herein, the memory 820 may be a separate device independent from the processor 810. Alternatively, the memory 820 may also be integrated into the processor 810.

In some embodiments, as shown in FIG. 13, the communication device 800 may further include a transceiver 830, and the processor 810 may control the transceiver 830 to communicate with other devices, and exemplarily, the transceiver 830 may send information or data to other devices, or receive information or data sent by other devices.

Herein, the transceiver 830 may include a transmitter and a receiver. The transceiver 830 may further include antennas, and the number of antennas may be one or more.

In some embodiments, exemplarily, the communication device 800 may be the terminal device of the embodiments of the present disclosure, and the communication device 800 may implement the corresponding process implemented by the first terminal in the various methods of the embodiments of the present disclosure, which will not be repeated herein for the sake of brevity.

In some embodiments, exemplarily, the communication device 800 may be the terminal device of the embodiments of the present disclosure, and the communication device 800 may implement the corresponding process implemented by the second terminal in the various methods of the embodiments of the present disclosure, which will not be repeated herein for the sake of brevity.

In some embodiments, exemplarily, the communication device 800 may be the terminal device of the embodiments of the present disclosure, and the communication device 800 may implement the corresponding process implemented by the relay terminal in the various methods of the embodiments of the present disclosure, which will not be repeated herein for the sake of brevity.

FIG. 14 is a schematic structural diagram of an apparatus of the embodiments of the present disclosure. The apparatus 900 shown in FIG. 14 includes a processor 910, the processor 910 may invoke a computer program from a memory and execute the memory to implement the method in the embodiments of the present disclosure.

In some embodiments, as shown in FIG. 14, the apparatus 900 may further include a memory 920. Herein, the processor 910 may invoke and execute a computer program from the memory 920 to implement the method in the embodiments of the present disclosure.

Herein, the memory 920 may be a separate device independent from the processor 910. Alternatively, the memory 920 may also be integrated into the processor 910.

In some embodiments, the apparatus 900 may further include an input interface 930. Herein, the processor 910 may control the input interface 930 to communicate with other devices or chips, and exemplarily, the input interface 930 may acquire information or data sent by other devices or chips.

In some embodiments, the apparatus 900 may further include an output interface 940. Herein, the processor 910 may control the output interface 940 to communicate with other devices or chips, and exemplarily, the output interface 940 may output information or data to other devices or chips.

In some embodiments, the apparatus may be applied to the terminal device in the embodiments of the present disclosure, and the apparatus may implement the corresponding process implemented by the first terminal in the various methods of the embodiments of the present disclosure, which will not be repeated herein for the sake of brevity.

In some embodiments, the apparatus may be applied to the terminal device in the embodiments of the present disclosure, and the apparatus may implement the corresponding process implemented by the second terminal in the various methods of the embodiments of the present disclosure, which will not be repeated herein for the sake of brevity.

In some embodiments, the apparatus may be applied to the terminal device in the embodiments of the present disclosure, and the apparatus may implement the corresponding process implemented by the relay terminal in the various methods of the embodiments of the present disclosure, which will not be repeated herein for the sake of brevity.

In some embodiments, the apparatus mentioned in the embodiments of the present disclosure may also be a chip. For example, the apparatus may be a system on chip, a system chip, a chip system or a system-on-chip chip, etc.

FIG. 15 is a schematic block diagram of a communication system 1000, provided by the embodiments of the present disclosure. As shown in FIG. 15, the communication system 1000 includes a first terminal 1010, a relay terminal 1020, and a second terminal 1030.

Herein, the first terminal 1010 may be used to implement the corresponding functions implemented by the first terminal in the above methods, the relay terminal 1020 may be used to implement the corresponding functions implemented by the relay terminal in the above methods, and the second terminal 1030 may be used to implement the corresponding functions implemented by the second terminal in the above methods, which will not be repeated herein for the sake of brevity.

It should be understood that the processor in the embodiments of the present disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically crasable programmable memory, the register, etc. The storage medium is located in the memory, and the processor reads the information in the memory and completes the steps of the above methods in combination with its hardware.

It may be understood that, the memory in the embodiments of the present disclosure may be a volatile memory or a non-volatile memory, or may include both volatile and non-volatile memories. Herein, the non-volatile memory may be a Read-Only Memory (ROM), a programmable read-only memory (Programmable ROM, PROM), an crasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. By way of example but not limitation, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, for example, the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

The embodiments of the present disclosure further provide a computer readable storage medium for storing a computer program.

In some embodiments, the computer readable storage medium may be applied to the terminal device in the embodiments of the present disclosure, and the computer program enables a computer to perform the corresponding process implemented by the first terminal in the various methods of the embodiments of the present disclosure, which will not be repeated herein for the sake of brevity.

In some embodiments, the computer readable storage medium may be applied to the terminal device in the embodiments of the present disclosure, and the computer program enables a computer to perform the corresponding process implemented by the second terminal in the various methods of the embodiments of the present disclosure, which will not be repeated herein for the sake of brevity.

In some embodiments, the computer readable storage medium may be applied to the terminal device in the embodiments of the present disclosure, and the computer program enables a computer to perform the corresponding process implemented by the relay terminal in the various methods of the embodiments of the present disclosure, which will not be repeated herein for the sake of brevity.

The embodiments of the present disclosure further provide a computer program product including computer program instructions.

In some embodiments, the computer program product may be applied to the terminal device in the embodiments of the present disclosure, and the computer program instruction enables a computer to perform the corresponding process implemented by the first terminal in the various methods of the embodiments of the present disclosure, which will not be repeated herein for the sake of brevity.

In some embodiments, the computer program product may be applied to the terminal device in the embodiments of the present disclosure, and the computer program instruction enables a computer to perform the corresponding process implemented by the second terminal in the various methods of the embodiments of the present disclosure, which will not be repeated herein for the sake of brevity.

In some embodiments, the computer program product may be applied to the terminal device in the embodiments of the present disclosure, and the computer program instruction enables a computer to perform the corresponding process implemented by the relay terminal in the various methods of the embodiments of the present disclosure, which will not be repeated herein for the sake of brevity.

The embodiments of the present disclosure further provide a computer program.

In some embodiments, the computer program may be applied to the terminal device in the embodiments of the present disclosure, the computer program when being executed on a computer, enables the computer to perform the corresponding process implemented by the first terminal in various methods of the embodiments of the present disclosure, which will not be repeated herein for the sake of brevity.

In some embodiments, the computer program may be applied to the terminal device in the embodiments of the present disclosure, the computer program when being executed on a computer, enables the computer to perform the corresponding process implemented by the second terminal in various methods of the embodiments of the present disclosure, which will not be repeated herein for the sake of brevity.

In some embodiments, the computer program may be applied to the terminal device in the embodiments of the present disclosure, the computer program when being executed on a computer, enables the computer to perform the corresponding process implemented by the relay terminal in various methods of the embodiments of the present disclosure, which will not be repeated herein for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for cach specific application, to implement the described functions, but such implementation should not be considered beyond the scope of the present disclosure.

It may be clearly understood by those skilled in the art that, for convenience and brevity of the description, the specific working process of the system, the apparatus and the unit described above may refer to the corresponding process in the above method embodiments, which will not be repeated herein.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be omitted or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in the form of a software functional unit and sold or used as an independent product, they may be stored in a computer readable storage medium. For this understanding, the technical solution of the present disclosure essentially, or a part of the technical solution that contributes to the prior art, or a part of the technical solution, may be embodied in the form of a software product, and the computer software product is stored in a storage medium, and includes a plurality of instructions for enabling a computer device (which may be a personal computer, a server, or a network device, etc.) to perform all or part of steps of the methods described in the various embodiments of the present disclosure. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the present disclosure, but the protection scope of the present disclosure is not limited thereto, and any skilled in the art familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A relay communication method, applied to a first terminal, wherein a relay connection is established between the first terminal and a second terminal through a relay terminal, and the method comprises:
receiving, by the first terminal, a first message; wherein the first message comprises at least one of the following: an end-to-end user identifier of the first terminal, or an end-to-end user identifier of the second terminal.

2. The method according to claim 1, further comprising:
sending, by the first terminal, a second message;
wherein the second message is used to instruct the first terminal to accept the end-to-end user identifier carried in the first message, or the second message is used to instruct the first terminal to reject the end-to-end user identifier carried in the first message.

3. The method according to claim 2, wherein
in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an end-to-end user identifier that is identical to the end-to-end user identifier carried in the first message, the second message is used to instruct the first terminal to reject the end-to-end user identifier carried in the first message.

4. The method according to claim 2, wherein in a case where the second message is used to instruct the first terminal to reject the end-to-end user identifier carried in the first message, the method further comprises:
receiving, by the first terminal, a third message; wherein the third message comprises at least one of the following: a reallocated end-to-end user identifier of the first terminal, or a reallocated end-to-end user identifier of the second terminal.

5. The method according to claim 3, wherein in a case where the second message is used to instruct the first terminal to reject the end-to-end user identifier carried in the first message, the method further comprises:
receiving, by the first terminal, a third message; wherein the third message comprises at least one of the following: a reallocated end-to-end user identifier of the first terminal, or a reallocated end-to-end user identifier of the second terminal.

6. The method according to claim 1, wherein
the first message comprises a PC5-radio resource control (RRC) message.

7. The method according to claim 1, wherein
the end-to-end user identifier is not equivalent to a layer 2 identifier.

8. A relay communication method, applied to a relay terminal, wherein a relay connection is established between a first terminal and a second terminal through the relay terminal, and the method comprises:
sending, by the relay terminal, a first message; wherein the first message comprises at least one of the following: an end-to-end user identifier of the first terminal, or an end-to-end user identifier of the second terminal.

9. The method according to claim 8, further comprising:
receiving, by the relay terminal, a second message, or forwarding, by the relay terminal, the second message;
wherein the second message is used to instruct the first terminal to accept the end-to-end user identifier carried in the first message, or the second message is used to instruct the first terminal to reject the end-to-end user identifier carried in the first message.

10. The method according to claim 9, wherein
in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an repeated end-to-end user identifier that is identical to the end-to-end user identifier carried in the first message, the second message is used to instruct the first terminal to reject the end-to-end user identifier carried in the first message.

11. The method according to claim 9, wherein in a case where the second message is used to instruct the first terminal to reject the end-to-end user identifier carried in the first message, the method further comprises:
sending, by the relay terminal, a third message, or forwarding, by the relay terminal, the third message; wherein the third message comprises at least one of the following: a reallocated end-to-end user identifier of the first terminal, or a reallocated end-to-end user identifier of the second terminal.

12. The method according to claim 10, wherein in a case where the second message is used to instruct the first terminal to reject the end-to-end user identifier carried in the first message, the method further comprises:
sending, by the relay terminal, a third message, or forwarding, by the relay terminal, the third message; wherein the third message comprises at least one of the following: a reallocated end-to-end user identifier of the first terminal, or a reallocated end-to-end user identifier of the second terminal.

13. The method according to claim 8, wherein
the first message comprises one of the following: a PC-S message, a discovery message, a PC5-radio resource control (RRC) message, a media access control-control element (MAC-CE), or an adaptation layer control protocol data unit (PDU).

14. A first terminal, wherein a relay connection is established between the first terminal and a second terminal through a relay terminal, and the first terminal comprises:
a processor and a memory, wherein
the memory is configured to store a computer program, and the processor is configured to invoke and execute the computer program stored in the memory, to enable the first terminal to perform:
receiving a first message; wherein the first message comprises at least one of the following: an end-to-end user identifier of the first terminal, or an end-to-end user identifier of the second terminal.

15. The first terminal according to claim 14, wherein the processor is configured to invoke and execute the computer program stored in the memory, to enable the first terminal further to perform:
sending a second message;
wherein the second message is used to instruct the first terminal to accept the end-to-end user identifier carried in the first message, or the second message is used to instruct the first terminal to reject the end-to-end user identifier carried in the first message.

16. The first terminal according to claim 15, wherein
in a case where there is a conflict between the end-to-end user identifier carried in the first message and a local configuration of the first terminal, the second message is used to instruct the first terminal to reject the end-to-end user identifier carried in the first message; or
in a case where the local configuration of the first terminal has an end-to-end user identifier that is identical to the end-to-end user identifier carried in the first message, the second message is used to instruct the first terminal to reject the end-to-end user identifier carried in the first message.

17. The first terminal according to 15, wherein in a case where the second message is used to instruct the first terminal to reject the end-to-end user identifier carried in the first message, the processor is configured to invoke and execute the computer program stored in the memory, to enable the first terminal further to perform:
receiving a third message; wherein the third message comprises at least one of the following: a reallocated end-to-end user identifier of the first terminal, or a reallocated end-to-end user identifier of the second terminal.

18. The first terminal according to 16, wherein in a case where the second message is used to instruct the first terminal to reject the end-to-end user identifier carried in the first message, the processor is configured to invoke and execute the computer program stored in the memory, to enable the first terminal further to perform:
receiving a third message; wherein the third message comprises at least one of the following: a reallocated end-to-end user identifier of the first terminal, or a reallocated end-to-end user identifier of the second terminal.

19. The first terminal according to claim 14, wherein
the first message comprises a PC5-radio resource control (RRC) message.

20. The first terminal according to claim 14, wherein
the end-to-end user identifier is not equivalent to a layer 2 identifier.
